(19) United States
(12) Patent Application Publication
(10) Pub. No.: US 2012/0101806 A1
(43) Pub. Date: Apr. 26, 2012

(54) SEMANTICALLY GENERATING PERSONALIZED RECOMMENDATIONS BASED ON SOCIAL FEEDS TO A USER IN REAL-TIME AND DISPLAY METHODS THEREOF

(76) Inventors: Frederic E. Davis, (US); Lisa K. Padilla, (US)

(21) Appl. No.: 13/192,253

(22) Filed: Jul. 27, 2011

Related U.S. Application Data
(60) Provisional application No. 61/368,140, filed on Jul. 27, 2010.

(51) Int. Cl. G06F 17/27

(52) U.S. Cl. 704/9

(57) ABSTRACT

Systems and methods of selecting recommendations for a user in an online environment are disclosed. In one aspect, embodiments of the present disclosure include a method, which may be implemented on a system, of performing semantic analysis on a content item associated with the user, online interactions of the user, and profile information related to the user to identify associated content metadata and keywords, assigning a weight to the content metadata and keywords based on semantic-type categories, comparing the content metadata and keywords to target metadata and keywords to identify recommendation matches, and selecting one or more recommendations to be provided to the user based on the recommendation matches.

### CLAIM OF PRIORITY

This application claims priority to U.S. Provisional Patent Application No. 61/368,140 entitled “METHOD AND SYSTEM FOR SOCIAL MEDIA PUBLISHING, SUBSCRIBING, COMMUNICATIONS, AND COMMERCE”, which was filed on Jul. 27, 2010, Attorney Docket No. 74210-8001.US00, the contents of which are expressly incorporated by reference herein.

### TECHNICAL FIELD

The present disclosure relates to the field of online social media including publishing content and offers and subscription thereof.

### BACKGROUND

Information from the web is increasingly being streamed to users in real-time. Popular streaming services, such as Twitter are credited with igniting the shift from browsing relatively static web pages to browsing real-time streams of short snippets of live information shared among a social network of friends. Other web players are also providing real-time streams of information to their users. For example, Facebook, FriendFeed, Google, and AOL now all offer real-time streams of information.

In addition to the social networks, the move to smart phones such as the iPhone has created the rise of applications that deliver summarized real-time streaming information. For example, smart phone applications on the iPhone now include iPhone mail, Google News, Bloomberg News, and many e-commerce smart phone micro-sites such as Amazon's marketplace.

These real-time streams of summarized information are a natural response to the massive amounts of information that users are inundated with on a daily basis. However, in addition to summarizing the otherwise massive amounts of information, the real-time nature of streaming services also offers immediacy to the user that is appealing and attention-grabbing. For this reason, many people now consider real-time streams the “new” news.

Unfortunately, streaming services have also created a variety of inconveniences and inefficiencies. For example, a user must now keep track of various real-time streams to which the user belongs and numerous groups of friends from the various real-time streams. However, logging into a streaming service such as Twitter, or using a Twitter application to participate in the Twitter stream, and also logging into other streaming services such as, Facebook, AOL, Plaxo, and LinkedIn, is an arduous task. In addition, it is also difficult to keep track of and manage various friends and contacts on the one or more of these various social networks or other online services. Although some services such as, Tweetdeck, and Seesmic aggregate the content from some of these sources, they do not allow aggregation, management, and communications to contacts or groups of contacts. Nor do the current services provide an independent social networking streaming service where users can register and add additional content and contacts to the aggregated real-time streams.

Furthermore, despite the enormous popularity and growth of streaming services, the streaming services have typically had trouble developing viable revenue models. Accordingly, a need exists for a new system of monetizing the attention of people browsing real-time streams of information in such a way that it does not interfere with the reading experience or appear to the users as spam or junk advertising.

### BRIEF DESCRIPTION OF THE DRAWINGS

FIG. 1 depicts a block diagram of an example environment suitable for selecting recommendations for a user.

FIG. 2 depicts a block diagram of the components of a host server that that selects recommendations for a user.

FIG. 3 depicts a block diagram illustrating an example of a semantic analysis system.

FIG. 4A depicts an example user interface illustrating a process of displaying electronic commerce offers.

FIG. 4B depicts an example user interface illustrating a process of displaying electronic commerce offers.

FIG. 5 depicts an example user interface illustrating the process of adding or editing tags in a content item received within the recommendation system.

FIG. 6 depicts an example user interface illustrating the process adding and/or editing tags associated with a user profile.

FIG. 7 depicts an example user interface illustrating the process of creating hybrid groups of fiends or contacts in a recommendation system and creating and displaying content recommendations to a user.

FIG. 8 depicts an example user interface illustrating an example content item with an embedded icon row.

FIGS. 9A-D depicts a flow diagram illustrating an example process for selecting recommendations for a user, according to one embodiment.

FIG. 10 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for selecting recommendations for a user in an online environment.

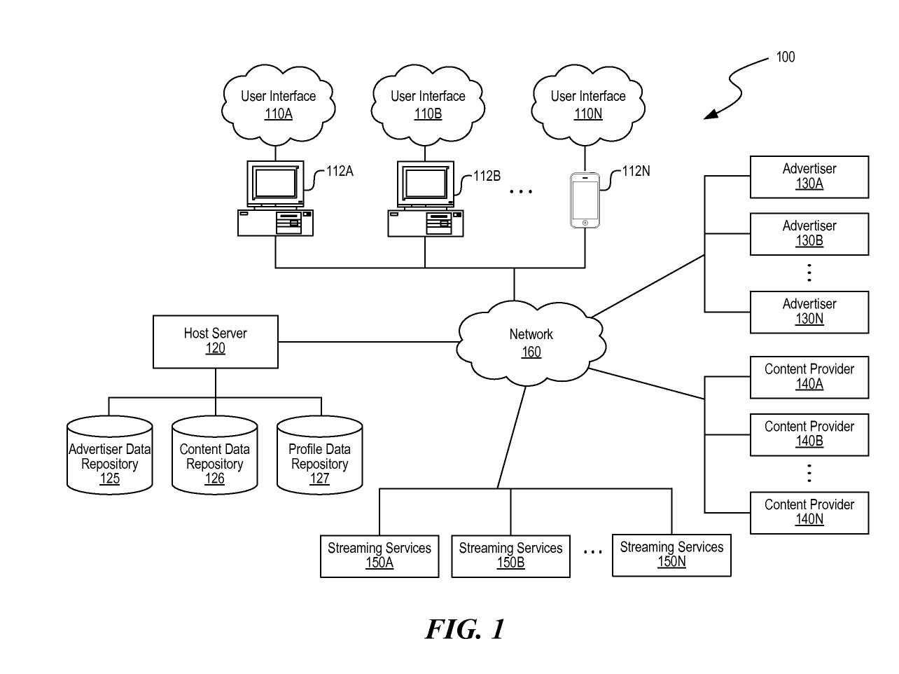

FIG. 1 depicts a block diagram of online environment 100 suitable for selecting electronic recommendations for a user, according to one embodiment. Online environment 100 includes a plurality of client devices 112A-N, a host server 120, data repositories 125-128, a plurality of advertisers 130A-N, a plurality of content providers 140A-N, a plurality of streaming services 150A-N, and network 160.

Host server 120 is configured to communicate with advertisers 130A-N, content providers 140A-N, and streaming services 150A-N in order to select recommendations for a user of the client device within environment 100.

The plurality of client devices 112A-N can be any system and/or device, and/or any combination of devices/systems that is able to establish a connection with another device, a server and/or other systems. The client devices 112A-N typically include a user interface 110A-N that includes an input device or devices and a display or other output functionalities to present data exchanged between the devices to a user. For example, the client devices can include, but are not limited to, a server desktop, a desktop computer, a computer cluster, a mobile computing device such as a notebook, a laptop computer, a handheld computer, a mobile phone, a smart phone, a PDA, a BlackBerry™ device, a Treo™, and/or an iPhone, etc. In one embodiment, the client devices 112A-N are coupled to a network 160.

The network 160, to which the client devices 112A-N are coupled, can be a telephonic network, an open network, such as the Internet, or a private network, such as an intranet and/or the extranet. For example, the Internet can provide file transfer, remote log in, email, news, RSS, and other services through any known or convenient protocol, such as, but not limited to the TCP/IP protocol, Open System Interconnections (OSI), FTP, UPnP, iSCSI, NSF, ISDN, PDH, RS-232, SDH, SONET, etc.

The network 160 can be any collection of distinct networks operating wholly or partially in conjunction to provide connectivity to the client devices and host server, and can appear as one or more networks to the serviced systems and devices. In one embodiment, communications to and from the client devices 112A-N can be achieved by, an open network, such as the Internet, or a private network, such as an intranet and/or the extranet.

The client devices 112A-N can be coupled to the network (e.g., Internet) via a dial-up connection, a digital subscriber loop (DSL, ADSL), cable modem, and/or other types of connection. Thus, the client devices 112A-N can communicate with remote servers (e.g., web server, host server, mail server, or instant messaging server) that provide access to user interfaces of the World Wide Web via a web browser, for example.

The advertiser data repository 125, content data repository 126, and a profile data repository 127 can store information such as software, descriptive data, images, system information, drivers, and/or any other data item utilized by parts of the host server 120 for operation. The advertiser data repository 125, content data repository 126, and profile data repository 127 can be managed by a database management system (DBMS), for example but not limited to, Oracle, DB2, Microsoft Access, Microsoft SQL Server, PostgreSQL, MySQL, FileMaker, etc.

The advertiser data repository 125, content data repository 126, and profile data repository 127 can be implemented via object-oriented technology and/or via text files, and can be managed by a distributed database management system, an object-oriented database management system (OODBMS) (e.g., ConceptBase, FastDB Main Memory Database Management System, JDOlnstruments, ObjectDB, etc.), an object-relational database management system (ORDBMS) (e.g., Informix, OpenLink Virtuoso, VMDS, etc.), a file system, and/or any other convenient or known database management package. As shown, the advertiser data repository 125, content data repository 126, and profile data repository 127 are coupled to host server 120. It is appreciated that, in some embodiments, The advertiser data repository 125, content data repository 126, and profile data repository 127 may be coupled to network 160.

In some embodiments, the host server 120 is configured to perform semantic analysis on advertisements transmitted by the advertisers 130A-N, content obtained from content providers 140A-N, and content streams obtained from streaming services 150A-N. In addition, in some embodiments host server 120 is also configured to monitor or otherwise obtain a history of the behavior of users operating client devices 112A-N and analyze that behavior to determine what content, products, and people the user interacts with, and the nature of that interaction. The host server 120 can also perform semantic analysis on the behavior data. In each case, the results of the semantic analysis may be, but is not limited to, keywords and/or metadata associate with the input. In some embodiments, the metadata may be in the form of tags that indicate semantic-type categories.

The host server 120 is able to communicate with client devices 112A-N, advertisers 130A-N, content providers 140A-N, and streaming services 150A-N via the network 160. In addition, the host server 120 is able to retrieve from and store data to advertiser data repository 125, content data repository 126, profile data repository 127, and behavior data repository 128. Client devices 112A-N can access the host server 120 to view an online recommendation of products, content, and contacts. Advertisers 130A-N can access the host server 120 to submit advertisements and advertisement profile information. Content providers 140A-N can access the host server 120 to provide content items. Alternatively or additionally, the host server 120 can access content provided by content providers 140A-N. Streaming services 150A-N can access the host server 120 to provide content streams. Alternatively or additionally, the host server 120 can access content streams provided by streaming services 1540A-N.

In one embodiment, the host server 120 is configured to communicate with the advertisers 130A-N, content providers 140A-N, and streaming services 150A-N. The host server 120 is enabled to allow the content providers 140A-N and the streaming services 150A-N to leverage semantic technology within host server 120 to improve the overall user experience of their sites (which may not be streaming services) while also providing the ability to locate and select recommendations for the user. In some embodiments, the recommendations are embedded within the individual content items with which they are associated. The host server 120 personalizes the recommendations to the user based on a variety of information. The recommendations can include, but are not limited to, electronic commerce offers for products, recommendations for data content that is most likely to be interesting to the user, and contacts that are likely to be interesting to the user.

In one embodiment, the host server 120 is configured to communicate with client devices 110A-N, advertisers 130A-N, content providers 140A-N, and streaming services 150A-N. The host server 120 is configured to aggregate content from the streaming services 150A-N and provide an independent aggregate streaming service. In some embodiments, the aggregate streaming service may be provided to users directly from the host server 120. In some embodiments, the aggregate streaming service may be provided to a content provider for hosting from the content provider site.

In some embodiments, the content items within the independent aggregate stream are embedded with the recommendations. The recommendations are subsequently provided by host server 120 or another host server to client devices 110A-N. The host server 120 personalizes the embedded recommendations to the user based on a variety of information. The recommendations can include, but are not limited to, electronic commerce offers for products, recommendations for data content that is most likely to be interesting to the user, and contacts that are likely to be interesting to the user.

In addition to aggregation, host server 120 may also provide management of each of the aggregate streaming services 150A-N. In one embodiment, host server 120 provides the ability to communication with both individual contacts from each of the streaming services 150A-N and user created groups of contacts belonging to more than one of the streaming services 150A-N.

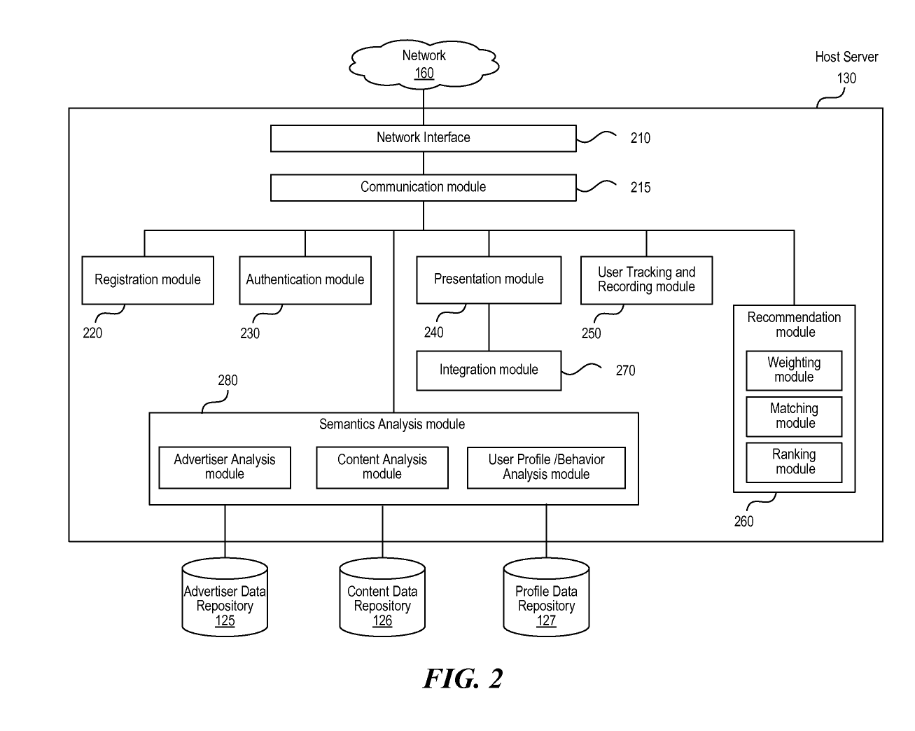

FIG. 2 depicts a block diagram illustrating an example recommendation system 200 that selects recommendations for a user, according to one embodiment. The recommendation system 200 includes a host server 120 coupled to an advertiser data repository 125, a content data repository 126, and a profile data repository 127.

The host server 120, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 2, the host server 120 includes a network interface 210, a registration module 220, an authentication module 230, a presentation module 240, a user tracking and recording module 250, a recommendation module 260, and a semantic analysis module 280. Additional or fewer modules can be included.

The host server 120 can be communicatively coupled to the advertiser data repository 125, and/or the content data repository 126, and/or the profile data repository 127, as illustrated in FIG. 2. In some embodiments, the advertiser data repository 125, and/or the content data repository 126, and/or the profile data repository 127 are partially or wholly internal to the host server 120. In other embodiments, the advertiser data repository 125, and/or the content data repository 126, and/or the profile data repository 127 are coupled to the host server 120 over network 160.

In the example of FIG. 2, the network interface 210 can be one or more networking devices that enable the host server 120 to mediate data in a network with an entity that is external to the server, through any known and/or convenient communications protocol supported by the host and the external entity. The network interface 210 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

In the example of FIG. 2, the host server 120 includes the communications module 215 communicatively coupled to the network interface 210 to manage a communication session over a plurality of communications protocols. In one embodiment, the communications module 215 receives data (e.g., audio data, textual data, audio files, etc.), information, commands, requests (e.g., text and/or audio-based), and/or text-based messages over a network.

Since the communications module 215 is typically compatible with receiving and/or interpreting data originating from various communication protocols, the communications module 215 is able to establish parallel and/or serial communication sessions with users of remote client devices, advertisers, content providers, and streaming services for data and command exchange (e.g., user information and/or user content).

One embodiment of the host server 120 includes a registration module 220. The registration module 220 can be any combination of software agents and/or hardware components able to register new users, content providers, and/or advertisers with the system and/or to create new accounts with the system. Advertisers can register for an account so that the system can semantically analyze the information related to their advertisement and/or products. Further, each advertiser with the system should have an account for tracking at least submitted advertisements, advertisement profile information, responses, and advertisement fees. Content providers can register for an account so that the content they provide can be semantically analyzed and recommendations generated for related products and services.

In some embodiments, users may also have accounts so that user behavior can be tracked and analyzed to determine the content, products, and contacts the user interacts with, and the nature of that interaction. Recommendations related to the content items can be personalized for users based on this information. In some embodiments, a new user can be asked to consent to the tracking and recording of his user behavior. The user is informed that maintaining the user's tracking information serves to enhance the quality and relevance of the served recommendations. In some embodiments, user profile information and registration information may be provided by the content provider. In this case, the user previously consented to sharing information with the content provider.

One embodiment of the host server 120 includes an authentication module 230. The authentication module 230 can be any combination of software agents and/or hardware components able to authenticate users, content providers, and advertisers. In some embodiments, authentication occurs by associating a user's username and password with an existing user account and/or associating a content provider's username and password with a content provider's account and/or associating an advertiser's username and password with an existing advertiser account. Unauthorized users, content providers, and/or advertisers can be directed to register with the system. In some embodiments, unauthorized advertisers can be permitted to submit advertisements without registering. However, advertisements for these unregistered advertisers may be given less priority.

One embodiment of the host server 120 includes a presentation module 240. The presentation module 240 can be any combination of software agents and/or hardware components able to present information processed in the host server 120. In some embodiments, presentation module 240 provides a full service aggregated social networking site. In some embodiments, presentation module 240 delivers a modular site that allows the features described herein to be integrated or embedded into another site. In some embodiments, presentation module 240 delivers a platform that analyzes content to suggest related products, content, services, and contacts in a real-time online environment.

One embodiment of the host server 120 includes an integration module 270. The integration module 270 can be any combination of software agents and/or hardware components able to integrate the features and functions of the host server 120 into other sites such as, for example, content provider sites. In some embodiments, the integration module 270 is capable of formatting and embedding recommendations to the user. The recommendations are integrated so that they can be displayed to a user on the content provider's site either within the content item itself or adjacent to the content item.

In some embodiments, the integration module 270 can be any combination of software agents and/or hardware components able to integrate various data content feeds into a single content feed. For example, the single content feed may integrate aspects of various social networking websites into an integrated hybrid social networking website having a single feed that is displayed to a user. In some embodiments, the integrated hybrid social networking website may be provided to the presentation module 240 for direct access by users. In some embodiments, the integrated social networking website may be provided to a content provider for integration into the content provider's site.

One embodiment of the host server 120 includes a user tracking and recording module 250. The user tracking and recording module 240 can be any combination of software agents and/or hardware components able to track and store user behavior on the content provider site and/or other sites. The user behavior can be tracked and analyzed to determine the content, products, and contacts that a user interacts with, and the nature of that interaction. This information is useful when identifying recommendations for individual users. In some embodiments, people or contacts that the user interacts with (e.g., related contacts) will also be tracked to determine the content, products, and contacts that those related contacts interact with, and the nature of those interactions. This tracked and recorded user information may be associated with a user in recommendation module 260 to identify personalized recommendations for a user including, but not limited to, content, contacts and products that the user may be interested in. These personalized recommendations may be presented to the user in the form of an electronic recommendation or offer.

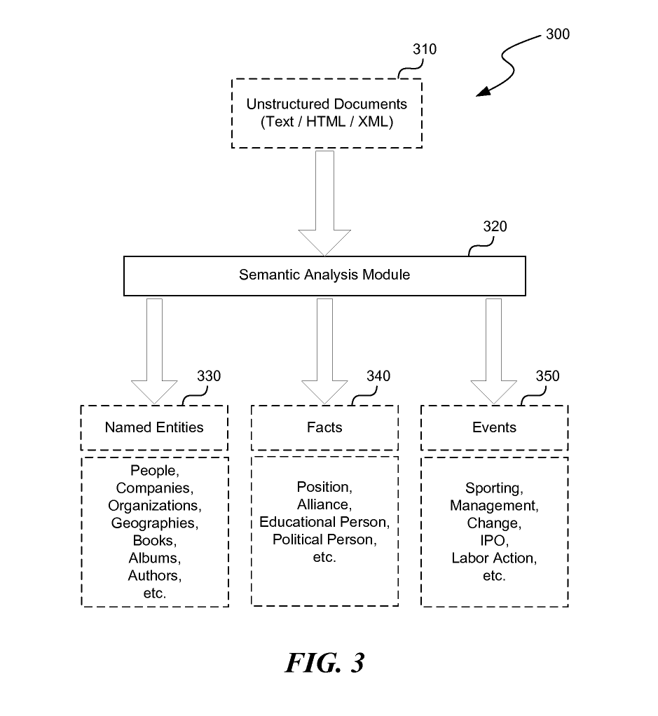

One embodiment of the host server 120 includes a semantics analysis module 280. The semantics analysis module 280 can be any combination of software agents and/or hardware components able to semantically analyze product, content and user information. In some embodiments, the semantics analysis module 280 provides keywords and metadata that are subsequently stored within advertiser data repository 125, content data repository 126, and profile data repository 127. The metadata may be in the form of semantic-type tags that are attached to the item being analyzed. An example of the input and output of the semantic analysis module 280 is further illustrated in FIG. 3.

In some embodiments, the semantics analysis module 280 includes an advertiser analysis module, a content analysis module and a user profile/behavior analysis module. The advertiser analysis module analyzes product related information and advertisements to identify keywords and meta data associated with those products and/or advertisements. The keywords and/or meta data associated with the products/and or advertisements can be stored in the advertiser data repository.

The content analysis module analyzes content provided by content providers to identify keywords and meta data associated with the content. The keywords and/or meta data associated with the content can be stored in the content data repository.

The user profile/behavior analysis module analyzes personal profiles of users to identify keywords and meta data associate with the user. The personal profiles may include tracked information, personal information entered by the user, and/or any other information gleaned from users.

One embodiment of the host server 120 includes a recommendation module 280. The recommendation module can be any combination of software agents and/or hardware components able to make recommendations to users. The recommendations are targeted based upon the keywords and meta data related to the user and the content item.

In some embodiments, the recommendation module 280 makes one or more recommendation that will be embedded into a content item real-time. For example, a real-time content item may be displayed to a user from a web server operated by a content provider or a streaming service and simultaneously processed by host server 120 to identify one or more recommendations related to that content item that the user (currently viewing the content item) may enjoy. In some embodiments, the output of the semantic analysis module 280 is presented to the user and the user is given an opportunity to modify (e.g., add or edit) the output associated with a given content item.

The recommendations can include, but are not limited to, electronic commerce offers for products, services, and/or paid online or offline content, suggestions for free online or offline content or sites the user may enjoy, and/or suggestions for business or personal contacts that the user may find interesting.

The recommendations are selected based on any number of factors. In some embodiments, when a new content item is received, the content item is semantically analyzed by the semantic analysis module 280 to determine keywords and meta data associated with the new content item. In some embodiments, the new content item is associated with an individual user, and thus the recommendation module 260 may accesses a user's profile that is associated with the new content item in order to identify keywords and meta data associated with the user.

In some embodiments, the recommendation module 280 includes a weighting module, a matching module, and a ranking module. The weighting module assigns weights to the keywords and meta data. The weighted values can be assigned based on any number of factors, based on a static or dynamic priority, or based on user input. In some embodiments, when a content item is received by the host server 120, the weighting module may assign a single weight to the keywords and various weights to the meta data based on types. In other embodiments, certain meta data types may be given no weight so that they are not considered in the recommendation process.

In some embodiments the meta data comprises tags that each have associated tag types. The weighting module assigns each of the tags a weight based on the tag type. Tag types may include, but are not limited to, user tags, source tags, profile tags, and system tags.

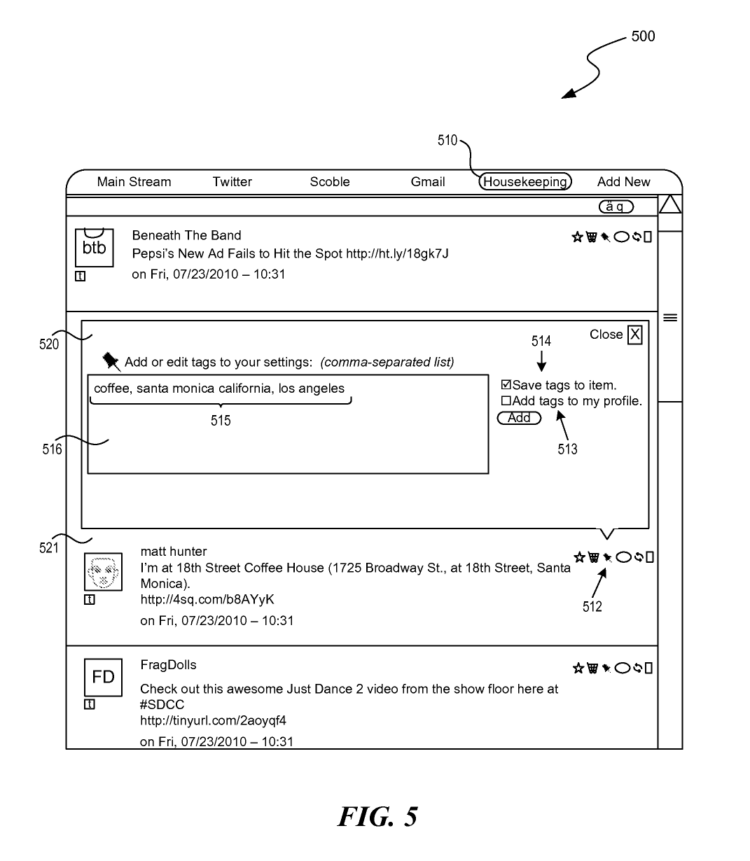

User tags are tags that are added to content items by users. Users may add or edit tags “in-line.” In some embodiments, the integrated hybrid social networking recommendation web site or the embedded recommendation engine allows users to add or edit tags in an area adjacent to the content feeds by clicking on an “Add or Edit Tags” icon. An example of a user adding and/or editing one or more user tags for a content item is illustrated in FIG. 5.

Source tags are tags that are associated with or attached to a content item at the time the source item is received or processed by the recommendation system. In some embodiments, the source tags are associated with or attached to the content item by the source of the content item. However, in some embodiments, the source tags may be associated with or attached to the content item by an intermediate system.

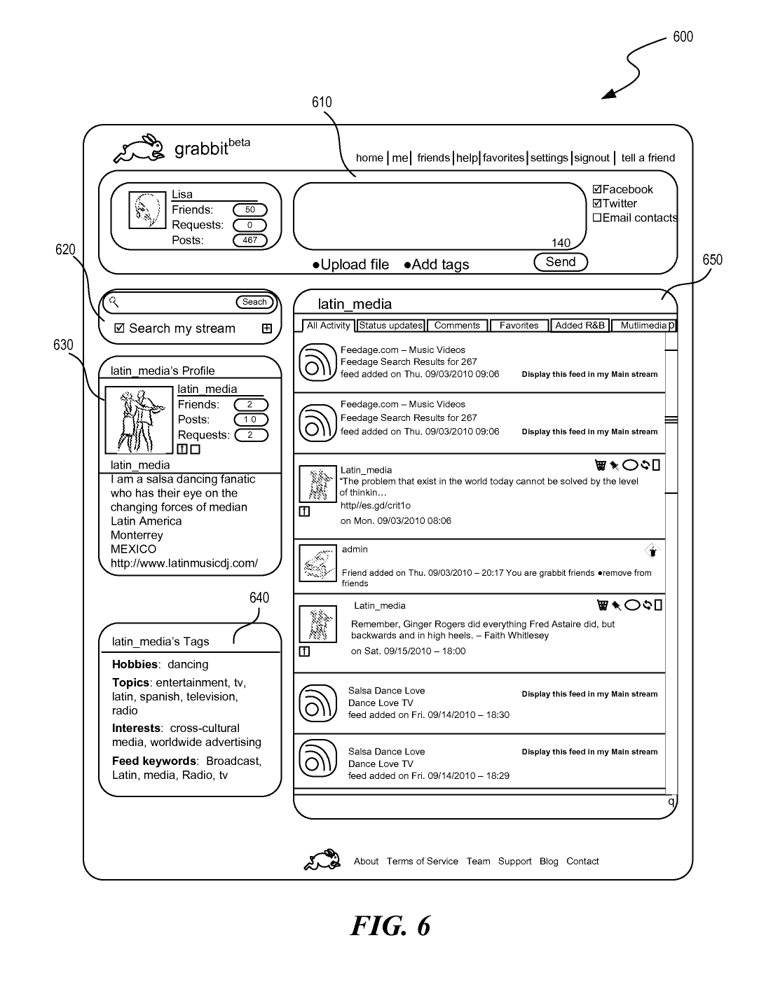

Profile tags are tags that are associated with or attached to a user profile. While profile tags are not typically directly associated with or attached to a content item, profile tags are used in conjunction with the content item tags to match target contents. In some embodiments, profile tags indicate general interests, hobbies, etc. entered by the user. In some embodiments, profile information indicates an aggregate of the behavior tracked by user tracking and recording module 250. In some embodiments, a user may add and/or edit user tags in an area adjacent to the various integrated content feeds within the integrated hybrid social networking website. An example of adding or editing profile tags is further illustrated in FIG. 6.

System tags are tags that are associated with or attached to a content item by the semantics analysis module 280. In some embodiments, the advertiser analysis module analyzes advertisements for products and/or services to determine the keywords and/or meta data associated with products and/or services. The advertiser keywords and/or meta data are then stored in the advertiser data repository 125 with information indicating the associated products and/or services. The advertiser keywords and/or meta data may then be used by the recommendation analysis module to identify product and/or service recommendations and electronic commerce offers for a user.

In some embodiments, the content analysis module analyzes content to determine target keywords and meta data. In some embodiments, the content items may be analyzed by the system in real-time and transferred to the recommendation module 260 for embedding recommendations in the content item. The content item may also be added to the content data repository 126. The content item may be stored in the content data repository 126 along with the associated content keywords and meta data and with information indicating the associated user that subscribed or received that data item in the recommendation system. In some embodiments, once stored in the content data repository, the content keywords and meta data may be compared to other incoming data items in the matching module in order to, for example, identify keyword and meta data matches between content items and target items (e.g., product advertisements).

In some embodiments, the matches are then ranked in the ranking module based on the underlying weighted values of the keywords and metadata that match. Recommendations are then made and presented based on the matches.

In some embodiments, the user profile/behavior analysis module analyzes user profiles and user behavior including the content, products, and people the user interacts with, and the nature of those interactions to determine profile keywords and meta data. In some embodiments, the profile keywords and meta data are added to the profile data repository 127 along with information indicating the associated user. In some embodiments, the recommendation module accesses the profile data repository to access the stored tags and keywords and use the tags and keywords to identify appropriate recommendations for the user.

FIG. 3 depicts a block diagram of semantic analysis environment 300, according to one embodiment. The semantic analysis environment 300 includes semantic analysis module 330. Semantic analysis module 330 may be an example of semantic analysis module 280 of FIG. 2, although other embodiments are possible.

Semantic analysis module 330 creates semantic metadata for submitted content using natural language processing (NLP), machine learning and other methods. In one embodiment, unstructured documents 310 are submitted to semantic analysis module 330. The unstructured documents 310 may include, but are not limited to, text documents, Hyper Text Markup Language (HTML) documents, and/or EXtensible Markup Language (XML) documents.

Semantic analysis module 330 processes the unstructured documents 310 and creates semantic metadata for the content. In some embodiments, semantic analysis module 330 creates named entities tags 330, facts tags 340, and event tags 350 for each unstructured document 310 that is submitted. Other results are also possible.

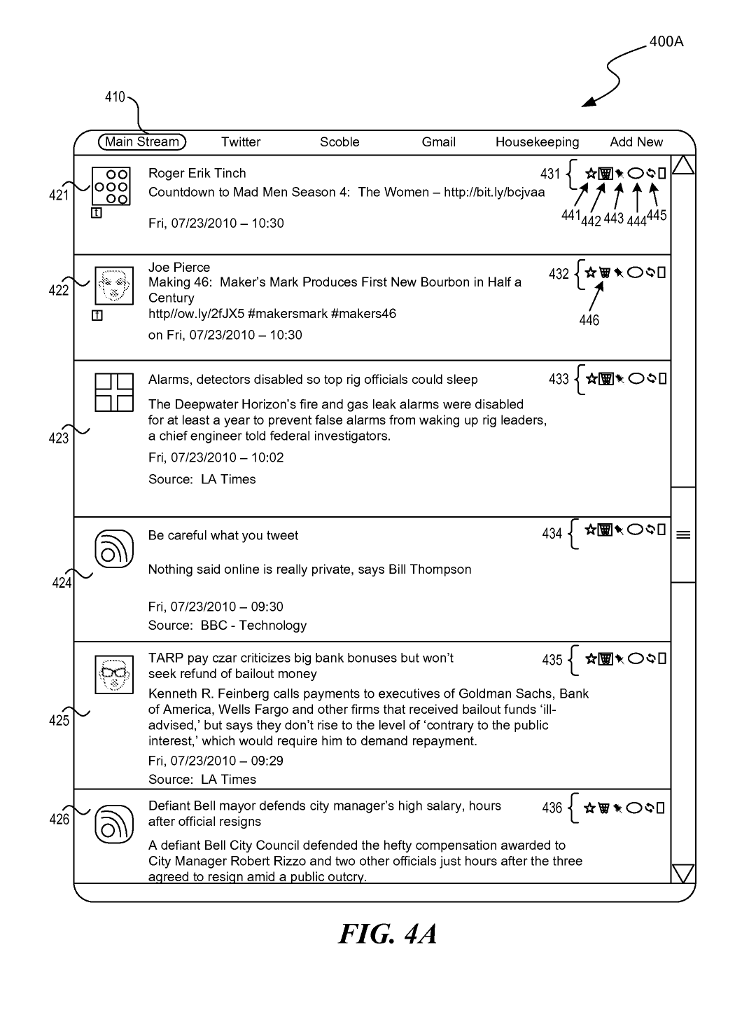

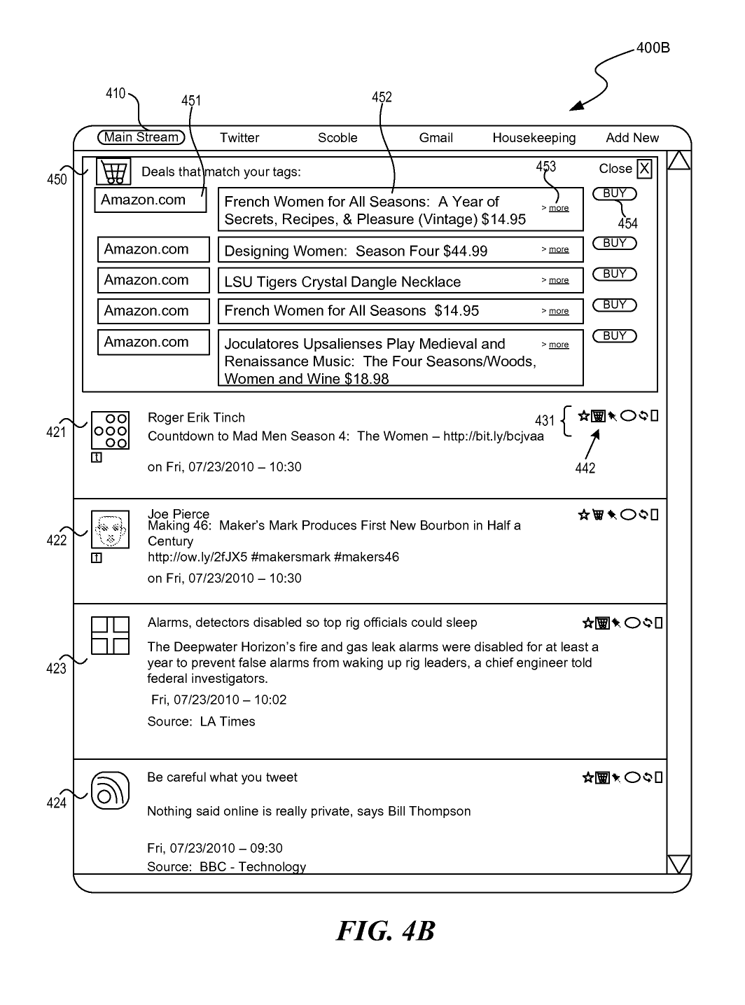

FIG. 4A depicts an example user interface 400A illustrating the process of displaying electronic commerce offers to a user, according to an embodiment. In this example, the main stream icon 410 at the top of user interface 400A is highlighted indicating that the main stream is being displayed to the user.

As shown, the main stream includes content items 421-426. In some embodiments, each content item is received from a real-time stream of information. The real-time streams of information may include, but are not limited to, Twitter streams, Facebook streams, FriendFeed streams, Google streams, LinkedIn streams, and/or AOL streams. Icon groups 431-436 are embedded within each stream of information along with related control mechanisms (not shown) that change the surrounding color of an icon to indicate a change in status for that icon.

In some embodiments, each icon represents a different function. In this example, icon 441 illustrates a favorites icon. Clicking the favorites icon embedded with a content item highlights the favorites icon within that content item and adds that content item to a group of favorite content items.

Icon 442 is a shopping icon. When the content items are received in the recommendation system, the content is analyzed using semantic analysis and tags are automatically created and associated with the content item. Those tags are then compared to target tags (e.g., in the advertiser data repository 125 and the content data repository 126 of FIG. 2) and if there are matches then the recommendation system makes one or more recommendations for the user. In some instances, the recommendations are for electronic commerce offers for products and/or services. When the recommendation system has identified one or more electronic commerce offers for products and/or services that are related to the content item, then the shopping cart is highlighted. In this example, the shopping icons embedding in content items 421, 423, 424, and 425 are highlighted indicating that electronic commerce offers related to those content items is available.

FIG. 4B depicts an example user interface 400B illustrating the process of displaying an electronic commerce offer as a result of a user clicking on a highlighted icon, according to an embodiment. In particular, when a user clicks on a highlighted shopping icon embedded in a content item, one or more electronic commerce offers are displayed within or adjacent to the content item. In this example, electronic commerce offer 450 is displayed adjacent to content item 421 when a user clicks or otherwise selects shopping icon 442.

In some embodiments, electronic commerce offers include numerous offers from various product and/or service vendors and/or advertisers. Each offer may indicate a vendor or advertiser 451, a product and/or service description 452, and a “more” icon 453 which, when clicked or selected by the user, allows the user to see the entire description 452. In some embodiments, each offer also includes a buy icon 454 allowing a user to directly purchase the item from the online display of electronic commerce offers.

FIG. 5 depicts an example user interface 500 illustrating the process of adding and/or editing tags associated with real-time content items as a result of a user clicking on the tags icon, according to an embodiment. In particular, when a user clicks on the tags icon embedded in a content item, a text window is displayed within or adjacent to the content item. In this example, a text window 520 is displayed within content item 521 when a user clicks or otherwise selects the tags icon 512.

In some embodiments, tags 515 are automatically created for content item 521 or source tags provided by the source of the content. The tags 515 are displayed to the user within a text window 516. Once a user has added or editing tags 515 within text window 516, the user can then click on select boxes 513 and/or 514 to save the tags to the individual's person profile and/or the content item. As shown, the recommendation system defaults to saving the tags only to the content item or select box 514.

FIG. 6 depicts an example user interface 600 illustrating the process of adding and/or editing tags associated with a user profile, according to an embodiment. In particular, each user has a user profile to which they can add or edit tags. The tags may be explicitly added by the user or the tags may be tags that are added as a result of semantic analysis that the user explicitly chooses to include in their profile.

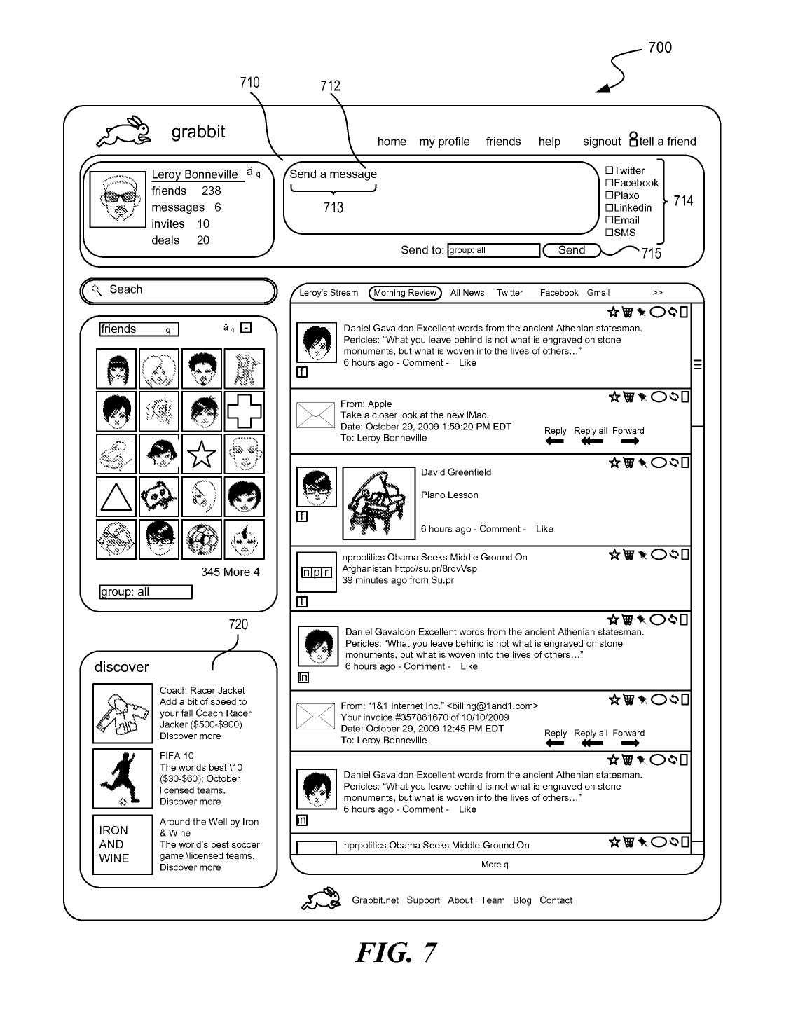

FIG. 7 depicts an example user interface 700 illustrating the process of creating hybrid groups of fiends or contacts in a recommendation system and creating and displaying content recommendations, according to an embodiment.

In some embodiments, a message pane 710 allows a user operating within an aggregated stream social environment to create hybrid groups of contacts from the various social networks and other real-time streams that the recommendation system is managing. A user may enter a message 713 in a message box area 712 and send the send the message to a hybrid group of friends or contacts.

In some embodiments, the hybrid group of friends or contacts is created and or edited via select boxes 714 that sit adjacent to the associated real-time streams and/or social networks. By clicking or otherwise selecting a box, the user may add one or all of the contacts from that real-time stream or network.

User interface 700 also illustrates an example of the process of displaying content product, service and content recommendations to a user in an independent pane 720. In this example, the recommendations are not necessarily tied to an individual content item but rather are determined based on an aggregate of information from the user's profile.

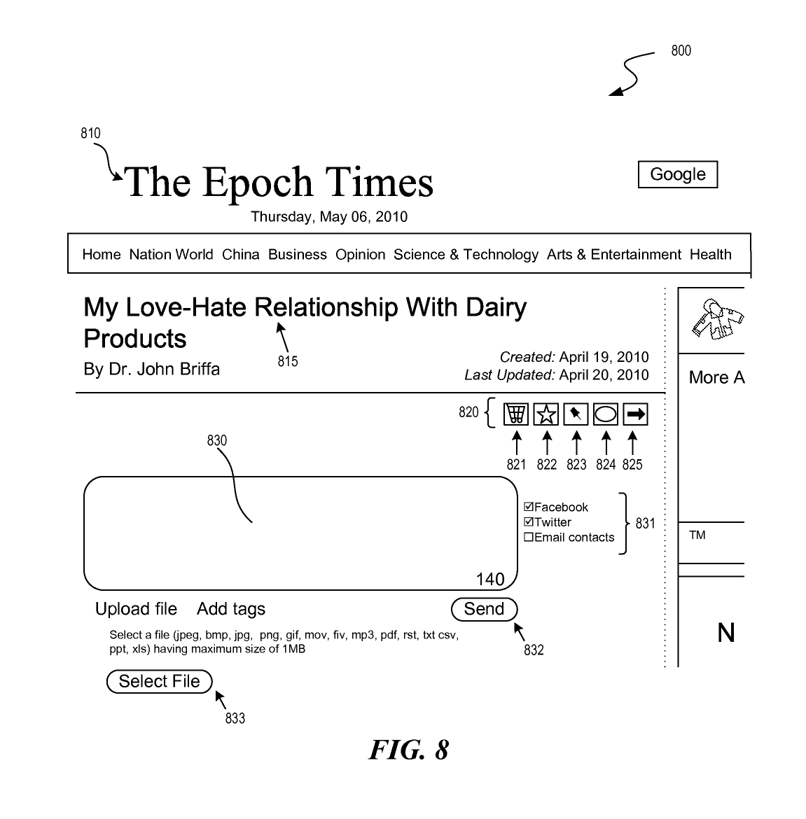

FIG. 8 depicts an example content item 800 with an embedded icon row 820, according to an embodiment. In this example, icon row 820 is embedded within non real-time content item 800 provided by a content provider 810. As shown, the content provider 810 is a newspaper, “The Epoch Times.” The content provider 810 may provide any number of non real-time content such as, but not limited to, blog content, traditional website content, newsletter content, profile content, and audio/video content.

In some embodiments, icon row 820 includes a shopping icon 821, a favorites icon 822, a tags icon 823, a comments icon 824, and a share icon 825. In this example, when a user clicks or otherwise selects the share icon 825, a message box 830 is displayed within or adjacent to content item 800. A user can subsequently type or otherwise enter a text message within message box 830. The user can then choose the contacts 831 that the user wants to send the message to. The contacts 831 may be selected from the users email contacts and various social networking and/or real-time sites to which the user belongs. In some embodiments, the user can choose the contacts 831 to which the user wants to send the message by selecting a checkbox adjacent to the name of the social networking or real-time content site.

In some embodiments, the user can also select a file to share with the message with message box 830 by clicking or otherwise selecting the select file icon 833. The user will then be prompted to select the file to share.

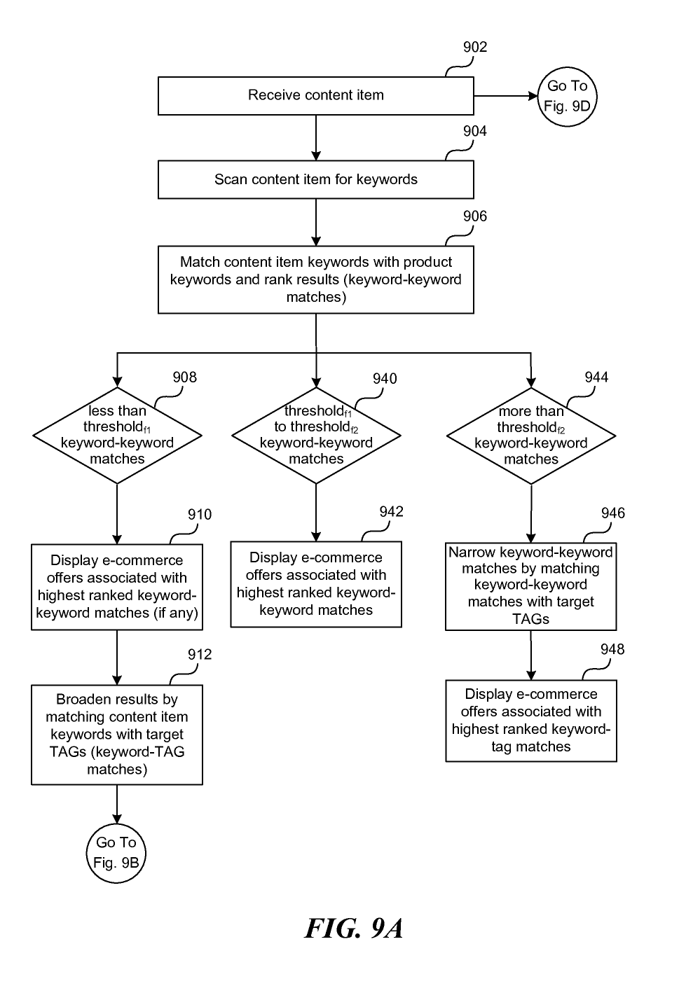

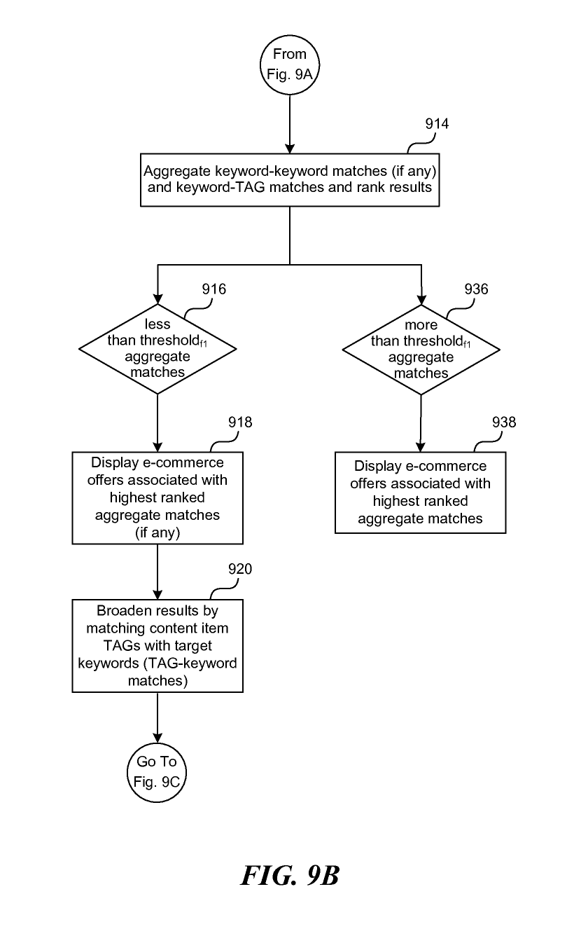

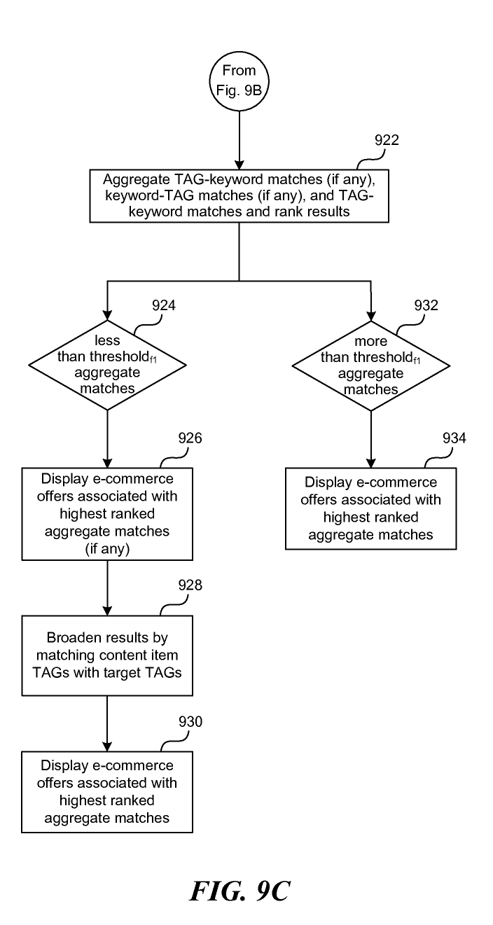

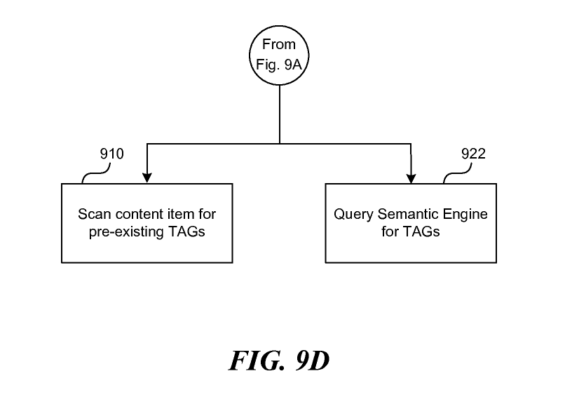

FIGS. 9A-D depicts a flow diagram 900 illustrating an example process for selecting a product recommendation for a user, according to one embodiment. In particular, flow diagram 900 illustrates an example of a method of weighting information according to its relevance and importance in order to locate electronic commerce product offers for a user. It is appreciated that while this example discusses selecting relevant electronic product offers for the user, any recommendation as disclosed herein may be selected for the user.

In process 902, a content item is received in the recommendation system. The content item may be a real-time content item (e.g. a short snippet of information generated by a user or a content provider within a social networking stream) or a non real-time content item (e.g., part of or an entire piece of information from a relatively static web page). In some embodiments, the content item may be provided by a participating content provider and/or by a streaming service in an online environment.

In process 904, the received content item is scanned for content item keywords associated with the content item. In some embodiments this process may involve extracting, parsing, processing, and/or otherwise identifying the content item keywords. In some embodiments, content item keywords may be determined using semantic analysis. However, other methods for extracting the content item keywords from the content item are also possible.

Once the keywords associated with the content item are identified, in process 906, the content item keywords are compared or matched with product keywords and the resulting keyword-keyword matches are ranked. In some embodiments, the product keywords are previously extracted, parsed, processed, and/or otherwise identified from a product recommendation (e.g., electronic commerce offer) prior to receiving the content item. In some embodiments, the product keywords may be identified in response to receiving the content item. In some embodiments, the product keywords may be identified at the same time as the content item keywords.

In some embodiments, the keyword-keyword matches are ranked according to relevance. In some embodiments, the relevance is determined based on the proximity of the keyword-keyword matches. For example, if the keyword-keyword matches are identical, then the keyword-keyword matches have a higher relevance than keyword-keyword matches that are substantial similar. Likewise, keyword-keyword matches that are substantial similar have a higher relevance than keyword-keyword matches that only loosely match. In some embodiments, the keyword-keyword matches are ranked according to other metrics.

In processes 908, 940, and 944, the quantity or number of keyword-keyword matches are processed and compared to first and second threshold values. In some embodiments, the first and second threshold values may be set by the recommendation system. In some embodiments, the user may set or edit the first and second recommendation values. In some embodiments, the first threshold is set to a value of three and the second threshold is set to a value of ten. In some embodiments, the recommendation system may first perform process 908 followed by process 940 and process 944. In some embodiments, processes 908, 940, and 944 may be performed concurrently or substantially concurrently as they are mutually exclusive.

Referring back to process 908, where the number of keyword-keyword matches are compared to the first threshold, and if the keyword-keyword matches are less than the first threshold, then in process 910, the recommendation system displays electronic commerce offers associated with the highest ranked keyword-keyword matches (if any). In some embodiments, the first threshold is set to three matches, and thus in this example, if less than three keyword-keyword matches are identified, then electronic commerce offers associated with the keyword-keyword matches are displayed for a user.

In process 912, the recommendation system attempts to broaden the results by matching the content item keywords with the target (or product tags) resulting in keyword-tag matches. In process 914, the recommendation system aggregates the keyword-keyword matches (if any) and the keyword-tag matches (if any) and ranks the results according to relevance. In some embodiments, the relevance is determined based on the proximity of the keyword-keyword matches and the proximity of the key-tag matches. In some embodiments, the keyword-keyword matches are given a higher weight or relevance than the keyword-tag matches.

In processes 916 and 936, the quantity or number of aggregate keyword-keyword matches and keyword-tag matches are processed and again compared to the first and second threshold values. In process 916, if the quantity or number of aggregate keyword-keyword matches and keyword-tag matches is less than the first threshold, then in process 918, the recommendation system displays electronic commerce offers associated with the aggregate keyword-keyword matches and keyword-tag matches (if any).

In process 920, the recommendation system again attempts to broaden the results by matching the content item tags with target keywords resulting in tag-keyword matches. In process 922, aggregates the keyword-keyword matches (if any), the keyword-tag matches (if any), and the tag-keyword matches (if any) and ranks the results. In some embodiments, the relevance is determined based on the proximity of the matches. In some embodiments, the keyword-keyword matches are given a higher weight or relevance than the keyword-tag matches, and the keyword-tag matches are given a higher weight or relevance than the tag-keyword matches.

In some embodiments, the tag-keyword matches are further weighted against each other based on the types of tags used to match against the keywords. For example, the tags may be weighted based on a priority of the tags. In one embodiment, the priority is (from highest priority to least priority): user tags, source tags, profile tags, and system tags.

In processes 924 and 932, the quantity or number of aggregate keyword-keyword matches, keyword-tag matches, and tag-keyword matches are again processed and compared to the first and second threshold values. In process 924, if the quantity or number of aggregate keyword-keyword matches (if any), keyword-tag matches (if any), and tag-keyword matches (if any) is less than the first threshold, then in process 926, the recommendation system displays electronic commerce offers associated with the aggregate keyword-keyword matches (if any), keyword-tag matches (if any), and tag-keyword matches (if any) according to the highest ranking matches.

In process 928, the recommendation system attempts to broaden the results by matching the content item tags with the target (or product tags) resulting in tag-tag matches and aggregates the keyword-keyword matches (if any), the keyword-tag matches (if any), the tag-keyword matches (if any), and the tag-tag matches (if any) and ranks the results based on relevance. In some embodiments, the relevance is determined based on the proximity of the matches. In some embodiments, the keyword-keyword matches are given a higher weight or relevance than the keyword-tag matches, the keyword-tag matches are given a higher weight or relevance than the tag-keyword matches, and the tag-tag matches are given the lowest priority.

In some embodiments, the tag-keyword matches and the tag-tag matches are further weighted against each other based on the types of tags used to match against the respective keywords and tags. For example, the tags may be weighted based on a priority of the tags. In one embodiment, the priority is (from highest priority to least priority): user tags, source tags, profile tags, and system tags. In some embodiments, the priority may be configurable by the user or otherwise.

In process 932, if the quantity or number of aggregate keyword-keyword matches (if any), keyword-tag matches (if any), and tag-keyword matches (if any) is greater than the first threshold, then in process 934, the recommendation system displays electronic commerce offers associated with the aggregate keyword-keyword matches (if any), keyword-tag matches (if any), and tag-keyword matches (if any) according to rank. In some embodiments, a limited number of the aggregate results are displayed to the user.

In process 936, if the quantity or number of aggregate keyword-keyword matches (if any) and keyword-tag matches (if any) is greater than the first threshold, then in process 938, the recommendation system displays electronic commerce offers associated with the aggregate keyword-keyword matches (if any) and keyword-tag matches according to rank. In some embodiments, a limited number of the aggregate results are displayed to the user.

In process 940, if the quantity or number of keyword-keyword matches is more than a first threshold but less than a second threshold, then in process 944, the recommendation system displays electronic commerce offers associated with the highest ranked keyword-keyword matches. In some embodiments, a limited number of the keyword-keyword matches are displayed to the user. In some embodiment the number of keyword-keyword matches displayed is set to the first threshold value.

In process 944, if the quantity or number of keyword-keyword matches is more than the second threshold, then in process 946, the recommendation system narrows the keyword-keyword matches by determining which of the keyword-keyword matches have associated content tags that match the target (or product tags). The narrowed results may then be weighted based on a priority of the tags. In one embodiment, the priority is (from highest priority to least priority): user tags, source tags, profile tags, and system tags. In some embodiments, the priority may be configurable by the user or otherwise.

In process 948. the recommendation system displays electronic commerce offers associated with the highest ranked keyword-keyword narrowed matches. In some embodiments, a limited number of the keyword-keyword narrowed matches are displayed to the user. In some embodiment the number of keyword-keyword matches displayed is set to the first threshold value.

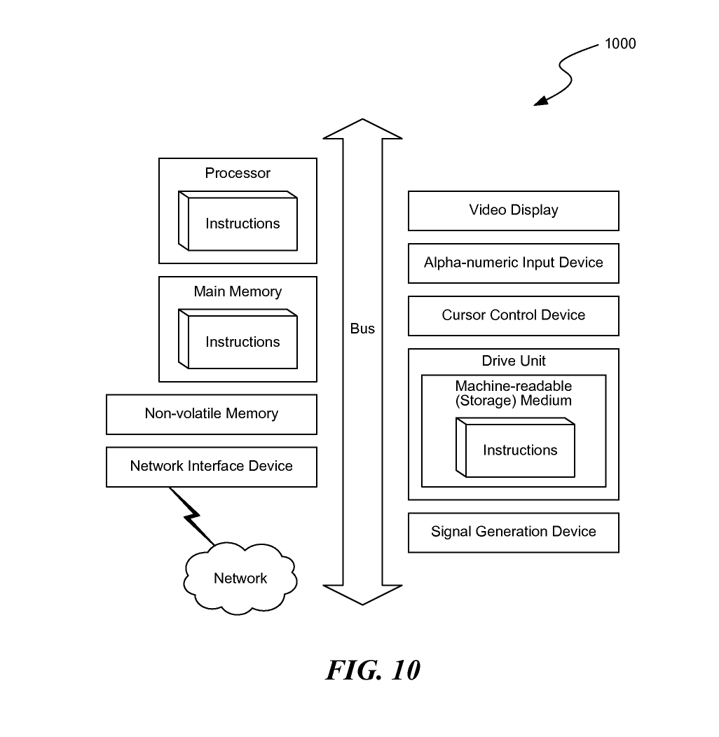

FIG. 10 shows a diagrammatic representation of a machine in the example form of a computer system 1000 within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

While the machine-readable (storage) medium is shown in an exemplary embodiment to be a single medium, the term “machine-readable (storage) medium” should be taken to include a single medium or multiple media (e.g., a centralized or distributed database, and/or associated caches and servers) that store the one or more sets of instructions. The term “machine-readable medium” or “machine readable storage medium” shall also be taken to include any medium that is capable of storing, encoding or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method for selecting recommendations for a user, the method comprising:
performing semantic analysis on a content item associated with the user, online interactions of the user, and profile information related to the user to identify associated content metadata and keywords;
assigning a weight to the content metadata and keywords based on semantic-type categories;
comparing the content metadata and keywords to target metadata and keywords to identify recommendation matches; and
selecting one or more recommendations to be provided to the user based on the recommendation matches.

2. The method of claim 1 wherein the selecting the one or more recommendations comprises:
ranking the recommendation matches based on the assigned weight of the metadata and keywords; and
selecting the one or more recommendations based on the ranking.

3. The method of claim 1 further comprising receiving input from the user adding or editing the content metadata and keywords.

4. The method of claim 1 further comprising performing semantic analysis on online interactions of other users related to the user and profile information associated with the other users to identify the content metadata and keywords.

5. The method of claim 1 wherein the one or more recommendations comprise an electronic commerce offer for a product personalized to the user.

6. The method of claim 1 wherein the one or more recommendations comprise a content recommendation personalized to the user.

7. The method of claim 1 wherein the one or more recommendations comprise a contact recommendation personalized to the user.

8. The method of claim 1 further comprising electronically presenting the one or more recommendations to the user.

9. The method of claim 8 wherein the content item is received from a real-time stream of information and the one or more recommendations are accessible via an icon embedded in the real-time stream of information.

10. The method of claim 9 wherein the one or more recommendations are electronically presented to the user within the real-time stream of information.

11. The method of claim 9 wherein the one or more recommendations are electronically presented to the user in an area adjacent to the real-time stream of information.

12. A system for selecting recommendations for a user, the system comprising:
a semantic analysis module operable to perform analysis on content items associated with a user, online interactions of the user, and profile information related to the user to identify associated content metadata and keywords, wherein the content metadata and keywords are associated with one or more semantic-type categories;
a recommendation module operable to assign a weight to the content metadata and keywords based on the one or more semantic-type categories, compare the content metadata and keywords to target metadata and keywords to identify recommendation matches, and select one or more recommendations to be provided to the user based on the recommendation matches.

13. The system of claim 12 wherein to select the one or more recommendations, the recommendation module is operable to rank the recommendation matches based on the assigned weight of the metadata and keywords, and select the one or more recommendations based on the ranking.

14. The system of claim 12 further comprising a network interface operable to receive input from the user adding or editing content metadata and keywords.

15. The system of claim 12 further comprising a user tracking and recording module operable to track and record online interaction of other users related to the user, and wherein the semantic analysis module is further operable to perform analysis on the online interactions of other users related to the user, and profile information associated with the other users related to the user, to identify the content metadata and keywords.

16. The system of claim 12 wherein the one or more recommendations comprise one or more of an electronic commerce offer for a product personalized to the user, a content recommendation personalized to the user, and a contact recommendation personalized to the user.

17. The system of claim 12 further comprising a presentation module operable to electronically present the one or more recommendations to the user.

18. The system of claim 17 further comprising an integration module operable to embed an icon in a real time stream, and wherein the presentation module is further operable to electronically present the one or more recommendations to the user via the embedded icon.

19. The system of claim 18 wherein the presentation module is operable to present the one or more recommendations to the user within the real-time stream of information or in an area adjacent to the real-time stream of information.

20. A computer-readable storage medium encoded with processing instruction for implementing a method performed by a computer, the method comprising:
performing analysis on a content item associated with the user and profile information related to the user to identify associated content metadata and keywords;
assigning a weight to the content metadata and keywords based on a relevance of the content metadata and keywords;
comparing the content metadata and keywords to target metadata and keywords to identify recommendation matches; and
selecting one or more recommendations to be provided to the user based on the recommendation matches.

21. The computer readable storage medium of claim 20 wherein the method further comprises receiving input from the user adding or editing the content metadata and keywords.

22. The computer readable storage medium of claim 20 wherein identifying the associated content metadata and keywords further comprises performing analysis on online interactions of the user and online interactions of other users related to the user.

23. The computer readable storage medium of claim 20 further comprising:
ranking the recommendation matches based on the assigned weight of the metadata and keywords; and
electronically presenting the one or more electronic recommendation to the user.

24. The computer readable medium of claim 23 wherein selecting the one or more recommendations is based on the ranking.

25. A method of selecting recommendations for a user, the method comprising:
receiving a content item transmitted by a content provider, wherein the content item is associated with the user;
identifying a plurality of content tags associated with the content item, wherein each content tag indicates a semantic-type category and is associated with a content tag type;
processing the content item to identify associated content keywords;
comparing the content keywords to target keywords resulting in a quantity of content matches;
selecting one or more recommendations to be provided to the user based on a ranking of the content matches; and
electronically presenting the one or more electronic recommendation to a user.

26. The method of claim 25 further comprising:
comparing the content keywords to target tags resulting in a quantity of keyword-tag matches; and
adjusting the content matches based on the keyword-tag matches.

27. The method of claim 25 further comprising:
applying a weight to each content tag type based on a relevance of the tag type;
comparing the content tags to the to the target keywords resulting in a quantity of tag-keyword matches; and
adjusting the content matches based on the tag-keyword matches.

28. The method of claim 27 further comprising:
applying a weight to each content tag type based on a relevance of the tag type;
comparing the content tags to the target tags resulting in a quantity of weighted tag matches; and
adjusting the content matches based on the weighted tag matches.
